(19) United States
(12) Patent Application Publication
(10) Pub. No.: US 2026/0317078 A1
(43) Pub. Date: Oct. 15, 2026

(54) PROTECTIVE DEVICE, TRANSPORT SYSTEM WITH A PROTECTIVE DEVICE, AND SYSTEM FOR PROCESSING PHARMACEUTICAL CONTAINERS

(71) Applicant: Bausch + Stroebel SE + Co. KG, Ilshofen (DE)

(72) Inventors: Wadim Wagner, Ilshofen (DE); Matthias Trump, Ilshofen (DE); Tobias Geiger, Ilshofen (DE)

(21) Appl. No.: 19/680,174

(22) Filed: May 18, 2026

Related U.S. Application Data
(63) Continuation of application No. PCT/EP2024/081232, filed on Nov. 5, 2024.

(30) Foreign Application Priority Data
Nov. 20, 2023 (DE) 10 2023 132 326.1

(51) Int. Cl. B65G 47/26; B65G 43/08

(52) U.S. Cl. CPC B65G 47/261; B65G 43/08; B65G 2201/0235

(57) ABSTRACT

A protective device in a system for processing pharmaceutical containers includes a guide that has or forms a transport path for containers. A blocking element on the transport path is transferrable from a blocking position, which blocks the transport path, to a release position, which opens the transport path. The device includes a securing element on the transport path that moves from a securing position to a disengaged position. In the securing position, the securing element blocks the blocking element from moving to the release position. When the securing element is in the disengaged position, the blocking element can move to the release position. The securing element can be upstream of the blocking element, contacted by a container, and transferred from the securing position to the disengaged position by movement of the container. The device can be part of a transport system and system for processing containers.

### CROSS-REFERENCE TO RELATED APPLICATIONS

This application is a continuation patent application of international application number PCT/EP2024/081232, filed on Nov. 5, 2024, and claims the benefit of German application number 102023132 326.1, filed on Nov. 20, 2023, which are incorporated herein by reference in their entireties and for all purposes.

### FIELD

The present disclosure relates to a protective device for a system for processing pharmaceutical containers, wherein the protective device is positioned or positionable in the system, in particular upstream of an outlet opening of the system for the containers, comprising a guide device which comprises or forms a transport path through which the containers are conveyable, in particular so as to be accumulated, and a blocking element which is arranged on the transport path and which is transferable from a blocking position, which blocks the transport path for the containers, to a release position, which releases the transport path for the containers, and vice versa.

The present disclosure further relates to a transport system comprising a transport body, a drive unit for the transport body and a protective device of the type described above, wherein the containers are conveyable into or in the transport path by means of the transport body, in particular so as to be accumulated.

The present disclosure furthermore relates to a system for processing pharmaceutical containers, comprising a working chamber with at least one processing station for the containers arranged therein, and a wall arrangement for delimiting the working chamber, wherein an outlet opening is formed in the wall arrangement through which the containers are conveyable by means of a transport system, in particular of the type described above.

### BACKGROUND

In such a system, the containers can be processed in at least one processing station, for example. The at least one station can comprise, for example, a weighing station, a filling station, a closing station, an inspection station, a crimping station and/or a sorting station. The system comprises a working chamber defined by the wall arrangement, which working chamber can be, for example, a cleanroom. An outlet opening is formed in the wall arrangement through which the containers can be discharged from the working chamber. The containers can be discharged, for example, after processing. Discharge before or during processing is also conceivable, for example at a reject chute. The outlet opening can also be arranged at transitions between working chambers.

For operational safety reasons, systems for processing the containers typically require a protective device. The type of protective device depends in particular on the dimensions of the outlet opening and/or how far a hazard (for example, due to moving machine parts) is arranged in a distance from the outlet opening within the working chamber.

It is known that at outlet openings straight transport paths without any finger guard for operating personnel are present. For example, sliders are used at the outlet opening, which are not tamper-proof.

Furthermore, S-chicane-shaped transport paths are implemented as finger guards by means of the shape of the transport path. In practice, it has been shown that the back pressure of supplied containers on such transport paths can be undesirably high and damage can occur. Furthermore, such protective devices prove to be unsafe.

Better protection is offered, for example, by hood-like covers that are positioned on the wall arrangement outside the working chamber and can cover an outlet for the containers. However, this entails restrictions on access to the outlet. In addition, increased space requirements are necessary.

Other types of protective devices include, for example, a bulkhead-like blocking element at the outlet opening that opens and closes under sensor control. However, the design of such protective devices is complex, resulting in high manufacturing costs and increased space requirements.

In a protective device of the type mentioned above, it is known for a blocking element to be arranged on the transport path, which releases the transport path in the release position. However, conventional protective devices have the disadvantage that the operating personnel can reach through the outlet opening into the working chamber and manipulate the blocking element. Such manipulation is carried out by operating personnel, for example, in order to manually rectify a malfunction in the system, as otherwise, in the event of a malfunction, an entire batch of processed containers may have to be discarded. However, this is not in line with occupational safety and the guidelines for good manufacturing practice.

As mentioned above, conventional systems and conventional protective devices have limitations in terms of operational safety, or the design of sufficiently safe protective devices is complex due to manufacturing costs or space requirements. Increased space requirements also lead to limitations in terms of usability.

An object underlying the present disclosure is to provide a protective device of the type mentioned above which offers greater operational safety while having, if possible, a structurally simple design.

### SUMMARY

In a first aspect of the present disclosure, a protective device for a system for processing pharmaceutical containers is provided, The protective device is positioned or positionable in the system, in particular upstream of an outlet opening of the system for the containers. The protective device comprises a guide device which comprises or forms a transport path through which the containers are conveyable, in particular so as to be accumulated, and a blocking element which is arranged on the transport path and which is transferable from a blocking position, which blocks the transport path for the containers, to a release position, which releases the transport path for the containers, and vice versa. The protective device comprises a securing element arranged on the transport path, which is transferable from a securing position to a disengaged position, and vice versa. In the securing position, the securing element blocks the blocking element assuming the blocking position from moving to the release position, and in the disengaged position, the blocking element is transferable from the blocking position to the release position. The securing element is positioned upstream of the blocking element in the supply direction of the containers, is contactable by a supplied container and is transferable from the securing position to the disengaged position as a result of the movement of the container.

In a second aspect of the disclosure, a transport system comprising

a transport body, a drive unit for the transport body and a protective device in accordance with the first aspect is provided. The containers are conveyable into or in the transport path by means of the transport body, in particular so as to be accumulated.

In a third aspect of the disclosure, a system for processing pharmaceutical containers, comprising a working chamber with at least one processing station for the containers arranged therein, and a wall arrangement for delimiting the working chamber is provided. An outlet opening is formed in the wall arrangement through which the containers are conveyable by means of a transport system in accordance with the second aspect. The protective device is arranged inside or outside the working chamber and the transport path extends to the outlet opening or passes through the outlet opening.

### BRIEF DESCRIPTION OF THE DRAWINGS

The foregoing summary and the following description may be better understood in conjunction with the drawing figures, of which:

FIG. 1: shows a schematic simplified representation of a system in accordance with the present disclosure for processing pharmaceutical containers in a preferred embodiment, wherein the system comprises transport systems in accordance with the present disclosure with protective devices in accordance with the present disclosure, in each case in a preferred embodiment;

FIG. 2: shows a perspective partial representation of the transport system in accordance with the present disclosure as shown in detail A in FIG. 1, wherein the transport system comprises the protective device;

FIG. 3: shows a partial representation of the protective device in a sectional view with supplied containers, wherein a securing element assumes a securing position and a blocking element assumes a blocking position;

FIG. 4: shows a perspective partial representation of the protective device, wherein the securing element is being transferred into a disengaged position by means of a container;

FIG. 5: shows a representation corresponding to FIG. 3, wherein the securing element assumes a disengaged position;

FIG. 6: shows a representation corresponding to FIGS. 3 and 5, wherein a container contacts the blocking element for transfer into a release position;

FIG. 7: shows a representation corresponding to FIGS. 3, 5 and 6, wherein the blocking element assumes the release position and the containers can be guided through a transport path of the protective device;

FIG. 8: shows a sectional view along line 8-8 in FIG. 3;

FIG. 9: shows a perspective partial representation of a further preferred embodiment of the transport system in accordance with the present disclosure with a further preferred embodiment of the protective device in accordance with the present disclosure;

FIG. 10: shows a representation corresponding to FIG. 4 in the case of the further protective device;

FIG. 11: shows a representation corresponding to FIG. 7 in the case of the further protective device;

FIG. 12: shows a view of the further protective device from an underside;

FIG. 13: shows a perspective representation of the protective device in accordance with the present disclosure in a further preferred embodiment;

FIG. 14: shows a representation corresponding to FIG. 3 in the case of the further protective device;

FIG. 15: shows a view corresponding to the situation in FIG. 14, wherein the protective device is shown from below;

FIG. 16: shows a representation corresponding to FIG. 7 in the case of the further protective device;

FIG. 17: shows a representation of the situation in accordance with FIG. 16, wherein the protective device is shown from below; and

FIG. 18: shows a representation corresponding to FIG. 6 in the case of a further preferred embodiment of the protective device in accordance with the present disclosure.

### DETAILED DESCRIPTION

Although the present disclosure is illustrated and described herein with reference to specific embodiments, the present disclosure is not intended to be limited to the details shown. Rather, various modifications may be made in the details without departing from the present disclosure.

The present disclosure relates to a protective device for a system for processing pharmaceutical containers, wherein the protective device is positioned or is positionable in the system, in particular upstream of an outlet opening of the system for the containers. The protective device comprises:
a guide device which comprises or forms a transport path through which the containers are conveyable, in particular so as to be accumulated; and
a blocking element which is arranged on the transport path and which is transferable from a blocking position, which blocks the transport path for the containers, to a release position, which releases the transport path for the containers, and vice versa.

The protective device further comprises a securing element which is arranged on the transport path and which is transferable from a securing position to a disengaged position and vice versa, wherein in the securing position, the securing element blocks the blocking element, assuming the blocking position, from moving to the release position, and in the disengaged position, the blocking element is transferable from the blocking position to the release position, and wherein the securing element is positioned upstream of the blocking element in the supply direction of the containers, is contactable by a supplied container, and is transferable from the securing position to the disengaged position as a result of the movement of the container.

In the protective device in accordance with the present disclosure, the blocking element, when it assumes the blocking position, is blocked by the additionally present securing element. The securing element can assume a securing position in which it blocks the blocking element in the blocking position. For this purpose, the blocking element and the securing element can, for example, be mechanically engaged with each other. This prevents manipulation attempts from the outside because the operator can no longer, unlike with a conventional protective device, transfer the blocking element to the release position by acting on the blocking element. However, during operation of the system comprising the protective device, there is a possibility that a supplied container may contact the securing element. In particular due to the back pressure of following containers, the securing element is transferred into the disengaged position. In the disengaged position of the securing element, the blocking element can be transferred into the release position in order to clear the transport path. This ensures the proper functioning of the protective device while maintaining a simple design. External manipulation by operating personnel is also made more difficult, thus increasing operational safety.

When used in a system for processing pharmaceutical containers, the containers will be, for example, vials, syringes, cartridges or ampules. The containers are transported, for example, standing upright, although hanging or lying transport is also conceivable. The protective device is used to ensure stable transport, for example, when processing vials.

It is advantageous if the blocking element is only transferable from the blocking position to the release position if the securing element has previously been transferred from the securing position to the disengaged position. This increases the operational reliability of the protective device and the system.

In accordance with the present disclosure, the securing element can be contacted by a supplied container and be transferred into the disengaged position as a result of the movement. For example, the securing element can be transferred into the disengaged position by means of just one container. It may be provided that two or more containers are necessary that contact the securing element in order to transfer it into the disengaged position.

It is advantageous if the securing element is held in the disengaged position by means of one or several containers. As long as contact with the container(s) is maintained, the securing element remains in the disengaged position. This ensures process reliability of the protective device during the intended operation of the system.

Alternatively or additionally, it may be provided for the securing element to be held in the disengaged position by means of the blocking element assuming the release position. For example, in this case the securing element and the blocking element can engage with each other by means of positive-locking and/or force-locking engagement. For example, if the blocking element returns to the blocking position (e.g. by means of a restoring element as explained below), the engagement can be released, so that the securing element can also return to the securing position (for example, by means of a restoring element as explained below).

It may be provided for the securing element, in the securing position, to engage the transport path, in particular from a left-hand side and/or a right-hand side of the transport path, with respect to a transport direction of the containers in the transport path. For example, the securing element engages the transport path from a left-hand lateral guide and/or a right-hand lateral guide and is at least partially arranged within the free cross-section of the transport path.

It may be provided for the securing element, in the securing position, to engage the transport path only from one side, for example from the left-hand side or from the right-hand side.

In the disengaged position, the securing element is preferably arranged completely outside the free cross-section of the transport path, so that the transport path is completely clear for the transport of the containers.

The guide device can comprise a guide body with a cover element, wherein, in the disengaged position, the securing element is received in a receiving space covered by the cover element. The guide body forms, for example, a lateral guide, with respect to the transport direction, on the left-hand or right-hand side of the transport path. The securing element can be arranged in the receiving space below the cover body in the disengaged position and, for example, immerse therein when transferred from the securing position to the disengaged position. The securing element can be stored in a space-saving manner in the receiving space and is preferably secured against external manipulation by means of the cover element.

The securing element can, for example, comprise a sliding surface for the containers, wherein the sliding surface is arranged obliquely relative to the transport direction of the containers in the transport path, in particular in the case of a straight course of the transport path, or the sliding surface is designed in an arcuate shape, in particular in the case of a curved transport path. A supplied container can contact the sliding surface and thereby apply a force to the securing element to transfer it into the disengaged position.

In a preferred embodiment of the present disclosure, the securing element is designed to be pivotable on the guide device via interacting bearing elements about a pivot axis in order to move the securing element. The bearing ensures reliable functioning of the securing element. The securing element can be pivoted back and forth between the securing position and the disengaged position, and out of the transport path or into the transport path (at least in portions).

The pivot axis is preferably oriented transversely and, in particular, perpendicularly to the transport path. When the transport is stationary, the pivot axis can, for example, be a z-axis, in particular a vertical axis.

The pivot angle of the securing element relative to the guide device can, for example, be up to 90° or more.

In a preferred embodiment of the present disclosure, the pivot axis can, for example, be arranged on the securing element so as to be leading with respect to the transport direction of the containers.

A preferred embodiment of the present disclosure may provide for the securing element to be designed to be displaceable on the guide device via interacting bearing elements. As a result, reliable functioning of the securing element can be ensured. By displacement, the securing element can be moved out of the transport path or (at least partially) into the transport path if moved back and forth between the securing position and the disengaged position.

The displacement direction can be, for example, transverse and, in particular, perpendicular to the transport direction of the containers. When containers are transported in a standing position, the displacement direction can be, for example, parallel to a floor guide for the containers, in particular horizontal.

It is advantageous if the protective device comprises or forms a restoring element for providing a restoring force under the action of which the securing element is transferable from the disengaged position to the securing position. This ensures reliable functioning of the protective device. In the absence of containers, the securing element can, for example, return to the securing position by means of the restoring element.

It is advantageous if the securing element can be transferred from the securing position to the disengaged position against the restoring force. The securing position thus defines a base position to ensure a blocking by the blocking element in the absence of containers.

To achieve a structurally simple design, the restoring element can be, for example, a mechanical spring element, wherein in practice a spring element in the form of a coil spring or a leaf spring proves to be advantageous.

An extension of the securing element along the transport path is, for example, such that it is contactable by at least two containers. For example, when containers are moving through the transport path, the securing element can be held in the disengaged position by means of a following container while a leading container is passing the securing element.

In a preferred embodiment of the present disclosure, the blocking element is arranged immediately downstream of the securing element in the transport direction of the containers, wherein a container can contact the securing element and the blocking element simultaneously. For example, as will be discussed below, the blocking element can be transferred from the blocking position into the release position as a result of the movement of the container. The containers can in a way themselves clear their way through the transport path at the securing element and at the blocking element.

To block the blocking element, the securing element and the blocking element preferably comprise interacting blocking members which, in the securing position of the securing element and in the blocking position of the blocking element, are in particular in mechanical engagement with each other. This makes a structurally simple configuration possible while ensuring reliable functioning of the protective device.

The engagement is released when the securing element assumes the disengaged position, for example after pivoting or displacing the securing element, so that the blocking element can be transferred into the release position.

The blocking members are designed, for example, as corresponding stop elements and can, for example, engage with each other in a positive-locking manner.

For example, the blocking members comprise a projection and a recess for the projection, wherein the projection engages in the recess when the securing element is in the securing position and abuts an edge of the recess. The projection can be arranged on the securing element and the recess can be arranged on the blocking element, or vice versa.

The pivot axis of the securing element is, for example, arranged upstream of the blocking member of the securing element with respect to the transport direction of the containers.

The blocking member of the securing element can, for example, be arranged at the end of the securing element with respect to the transport direction.

The blocking member of the blocking element can, for example, be arranged on the blocking element so as to be leading with respect to the transport direction.

In a preferred embodiment of the present disclosure, the guide device can comprise a guide body with a cover element, wherein the blocking members are arranged in a receiving space covered by the cover element. In this way, the blocking members are protected from external intervention, which makes the protective device more tamper-proof and increases operational safety.

It may be provided for the blocking element, in the blocking position, to engage the transport path, in particular from a left-hand side and/or a right-hand side of the transport path, with respect to a transport direction of the containers.

As explained above using the example of the securing element, the blocking element can, for example, project into the transport path from a left-hand lateral guide and/or a right-hand lateral guide when it assumes the blocking position.

It may be provided for the blocking element to engage the transport path from only one side, from the left or from the right.

For transfer into the disengaged position and the release position, the securing element in the securing position and the blocking element in the blocking position can, for example, engage the transport path from the same side and be movable in the same direction out of the transport path.

In the release position, the blocking element is preferably arranged completely outside the free cross-section of the transport path, so that the transport path is completely clear for the containers.

The guide device can form a recess in which the blocking element is arranged in the release position, wherein the recess is arranged laterally next to the transport path and is formed, for example, by a guide body. For transfer from the release position into the blocking position, the blocking element can be movable from the recess into the transport path to engage therewith. However, it may be provided for the blocking element to continue to engage in the recess in the blocking position, wherein in particular any engagement from the transport path into the recess is blocked in this way. This increases operational reliability. The operator is prevented from or at least hindered in reaching into the recess in order to manipulate the protective device.

The blocking element is advantageously contactable by a supplied container and is transferable from the blocking position to the release position as a result of the movement of the container. One such preferred embodiment of the present disclosure has already been mentioned. After release of the blocking element, the blocking element can in a way be transferred into the release position by the container itself. As explained in connection with the securing element, it may be provided that at least one container transfers the blocking element. This may in particular be a single container.

The blocking element is advantageously held in the release position by means of one container or several containers.

The blocking element advantageously comprises a sliding surface for the containers, which can be contacted for transfer from the blocking position to the release position. The sliding surface is arranged obliquely relative to the transport direction of the containers in the transport path, in particular in case of a straight course of the transport path.

The blocking element can, for example, extend along the transport path in such a way that it is contactable by at least two containers.

Alternatively, the blocking element can, for example, extend along the transport path in such a way that it is contactable by only one container.

The guide device can comprise a guide body with a cover element on the top, wherein the blocking element projects beyond the cover element in a direction away from the transport path. The guide body forms, for example, a left-hand or right-hand lateral guide. The blocking element is, for example, arranged in the aforementioned recess and projects beyond the cover element, upwards during upright transport. For example, the respective position of the blocking element can thus be detected and monitored from outside the system.

In practice, it proves advantageous if the blocking element on the guide device is designed to be pivotable about a pivot axis via interacting bearing elements. By pivoting, the blocking element can be pivoted, in particular, from the blocking position out of the transport path and into the disengaged position, and conversely into the transport path.

The pivot axis is, for example, oriented transversely and, in particular, perpendicularly to the transport path.

The pivot angle of the blocking element relative to the guide device can, for example, be up to 90° or more.

It may be provided for the pivot axis to be arranged so as to be leading on the blocking element with respect to the transport direction of the containers.

The blocking member of the blocking element is, for example, arranged in the region of the pivot axis on the blocking element.

In a preferred embodiment of the present disclosure, the blocking element can be designed to be displaceable relative to the guide device, wherein preferably interacting bearing elements are provided.

It is advantageous if the protective device comprises or forms a restoring element for providing a restoring force under the action of which the blocking element is transferable from the release position to the blocking position. This ensures reliable operation of the protective device while maintaining a simple design.

It can be advantageous if the blocking element is transferable from the blocking position to the release position against the restoring force. This defines the blocking position as the default position of the blocking element and increases operational reliability of the protective device.

To achieve a structurally simple design, the restoring element can be a mechanical spring element, for example a torsion spring.

For example, if the blocking element is designed in such a way that it can be contacted by just one container, it could be provided for the blocking element to be transferred from the release position back into the blocking position after each container has passed through, in particular under the action of the restoring element. As a result, the blocking element can have a compact design, wherein in the blocking position, for example, it blocks only part of the cross-section of the transport path. To further block the transport path for larger containers, a further blocking element could be provided that engages the transport path from an opposite side.

Accordingly, it can be provided for the protective device to comprise a further blocking element which in a blocking position preferably engages in the transport path from a side opposite the blocking element and is transferable into a release position, and vice versa, wherein the further blocking element releases the transport path in the release position. For example, the transport path is blocked by the blocking elements assuming the blocking position in each case.

The further blocking element can, for example, be designed to be partially or completely corresponding or functionally identical to the blocking element. For instance, at least one of the following can be provided, with reference to the preceding descriptions: the possibility of pivoting and/or displacing relative to the guide device, in particular with a bearing; arrangement in a recess of the guide device when the release position is assumed; transfer from the release position into the blocking position by means of a restoring element; transfer from the blocking position into the release position against the action of a restoring element; transfer from the blocking position into the release position by means of a supplied container; provision of a sliding surface for the container; holding in the release position by means of at least one container.

The blocking element and the further blocking element can, for example, engage with each other when the respective blocking position is assumed, for example by positive-locking and/or force-locking engagement. In this context, the blocking element can, in particular, block the further blocking element against transfer from the blocking position to the release position. This can eliminate the need for a separate securing element for the further blocking element. For example, transferring the blocking element into the release position removes the engagement, so that the further blocking element can also be transferred into the release position. This is preferably done by contact with the supplied container.

In a preferred embodiment of the present disclosure, it can be provided for the blocking element to be held in the release position by means of the securing element which assumes the disengaged position. For example, in this case the securing element and the blocking element can engage with each other by means of positive-locking and/or force-locking engagement. If, for example, a force from one or more containers on the securing element is absent (for example, when the transport path is empty), the securing element can be moved back into the securing position (for example, by the restoring element as explained above). This can undo the engagement, so that the blocking element can also return to the blocking position (for example, as a result of the restoring element as explained above).

In one embodiment of the present disclosure, it can be provided for a contour of the blocking element to have the form of a circular arc in a plan view of the transport path. The angle of the circular arc can be approximately 20° to 80°, preferably approximately 30° to 50°.

The blocking element can be designed as a hollow body, at least in portions. This keeps the mass of the blocking element low, so that it can be reliably transferred from the blocking position into the release position when a container is moved.

Applying force to the blocking element which has assumed the blocking position can, for example, subject the securing element to a force directed in the direction of the securing position, so that the protective device can have a self-locking function.

The securing element and/or the blocking element can be arranged, for example, on a straight path portion of the transport path. It may be provided for the securing element and/or the blocking element to be arranged on a curved portion of the transport path.

The protective device can, for example, comprise or form a tunnel through which the containers are movable in the transport path and which covers the blocking element and/or the securing element. The tunnel can increase the operational reliability of the protective device. For example, an operator may be prevented from acting on the blocking element and/or the securing element from the outside.

The guide device can comprise two guide bodies arranged at a distance from each other, between which the transport path is formed. The guide bodies form, for example, a left-hand lateral guide and a right-hand lateral guide. A respective guide body can, in portions, form a wall arrangement of the tunnel. The tunnel can therefore be divided into two parts, with each part being provided by a guide body.

The protective device is advantageously designed such that it can be used in a variety of ways with different containers. Components of the protective device may have container-specific properties. Here, in particular, it is provided that two or more format sets with respective format parts are available, wherein the format parts of different format sets differ from each other in terms of at least one container-specific property.

For example, the guide bodies of the guide device are format parts.

It is conceivable for the blocking element to be a format part.

It can be provided that the securing element is a format part.

In a different advantageous embodiment, it can be provided that the securing element is format-independent.

The protective device can be designed without sensors and free of drives for the securing element and/or the blocking element.

It can be provided that the protective device comprises a sensor device with which the respective position of the securing element and/or the blocking element can be determined. Depending on a signal from the sensor device, the transport system or the system can be controlled, for example.

The protective device is advantageously suited for retrofitting existing systems. It is conceivable for the guide device with securing element and blocking element of an existing system to be installed and there replace an existing transport path, wherein, advantageously, a transport body conveying the containers does not have to be replaced.

As mentioned at the outset, the present disclosure also relates to a transport system.

A transport system in accordance with the present disclosure comprises a transport body, a drive unit for the transport body and a protective device of the type described above, wherein the containers are conveyable into or in the transport path by means of the transport body, in particular so as to be accumulated.

The transport body can be designed in different ways. It could be, for example, a transport wheel, in particular a star wheel, a screw conveyor, a linear conveyor, a cell chain with transport links, or a mover in case of magnetic levitation transport. Other types of transport bodies are conceivable.

As further mentioned, the present disclosure also relates to a system.

A system for processing pharmaceutical containers in accordance with the present disclosure comprises a working chamber with at least one processing station for the containers arranged therein and a wall arrangement for delimiting the working chamber, wherein an outlet opening is formed in the wall arrangement through which the containers are conveyable by means of a transport system of the type described above, wherein the protective device is arranged inside or outside the working chamber and the transport path extends to the outlet opening or passes through the outlet opening. Depending on the installation space available, the protective device could be positioned inside or outside the working chamber.

The advantages mentioned in connection with the explanation of the protective device in accordance with the present disclosure can also be achieved in the transport system in accordance with the present disclosure and in the system in accordance with the present disclosure. Advantageous embodiments of the transport system in accordance with the present disclosure and the system in accordance with the present disclosure follow from advantageous embodiments of the protective device in accordance with the present disclosure. In either case, reference can be made to the above statements.

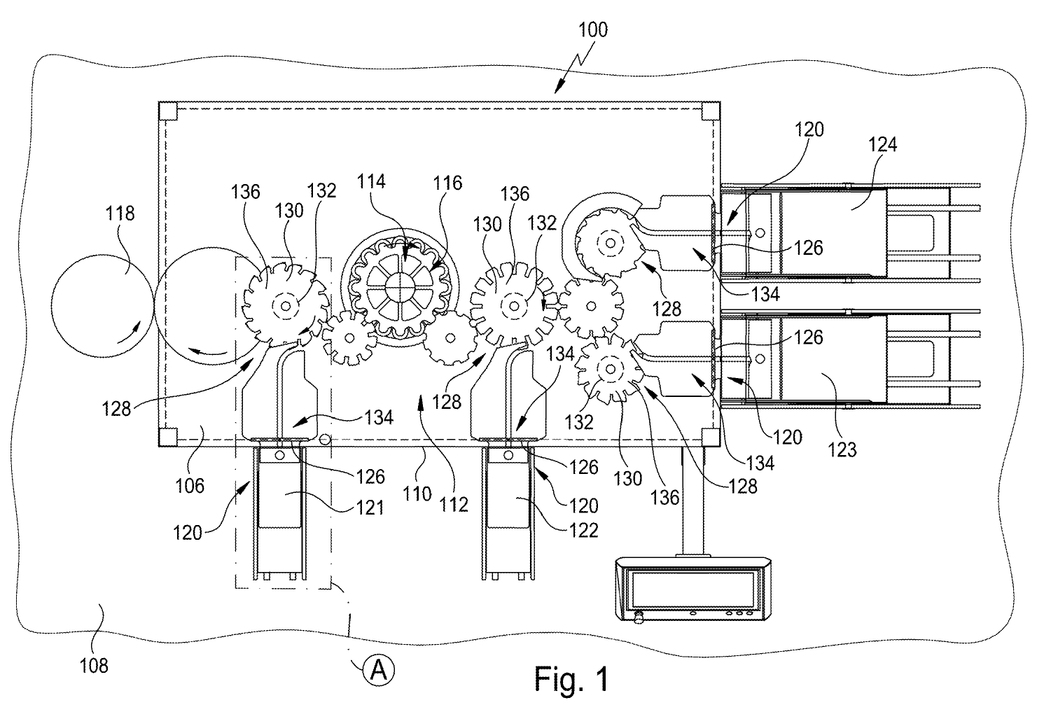

FIG. 1 shows a schematic representation of an advantageous embodiment of the system in accordance with the present disclosure, which is denoted overall by reference numeral 100. In the present case, the system 100 is set up for processing pharmaceutical containers 102. The containers 102 are in this case vials 104 (small bottles). However, the scope of application of the present disclosure is not limited thereto.

The system 100 comprises a frame 106, which is positioned on a set-down surface 108 of a room, for example a laboratory. A wall arrangement 110 defines a working chamber 112 above the frame 106. The working chamber 112 can, for example, be a cleanroom, wherein the wall arrangement 110 is, for example, the wall arrangement of a machine guard.

At least one processing station 114 for processing the containers 102 is arranged in the working chamber 112. In the present example, the processing station 114 is a schematically represented crimping station 116. The containers can be transported into the working chamber 112 with transport bodies via an inlet 118.

In the present example, the system 100 has a plurality of outlets 120 for the containers 102. For example, a reject chute 121 is arranged upstream of the crimping station 116. A further reject chute 122 is, for example, arranged downstream of the crimping station 116. There are, for example, two outlets 120 on the exit side, which serve for storing processed containers 102 sealed with crimped caps. Reference numerals 123 and 124 designate the removal regions at such outlets 120. Corresponding removal regions are present at the reject chutes 121, 122.

It will be appreciated that the number of outlets 120 and the type of processing station 114 are merely examples.

At each outlet 120, an outlet opening 126 is formed in the wall arrangement 110. Through the outlet opening 126, the containers 102 can pass from the working chamber 112 into the respective removal region 121 to 124 where they are manually removed by an operator or are processed automatically.

In practice, the system 100 is subject to safety regulations. Depending on the size of the outlet opening 126 and the distance of machine components in the working chamber 112 from the outlet opening 126, it must be ensured that operating personnel cannot reach into the working chamber 112. If the outlet openings are sufficiently small 126 and/or there is a large distance from machine components, a protective device may be unnecessary.

The present disclosure relates to protective devices that are necessary for achieving operational safety in the system 100. Of course, the protective devices described herein are also suitable for systems where a protective device is not mandatory. Even in such systems, they contribute to increasing operational safety.

The system 100 comprises a transport system 128 associated with a respective outlet 120. The transport system 128 comprises a transport body 130 driven by a drive unit 132.

The respective transport system 128 is configured in accordance with the present disclosure and, in the present case, is shown and explained in a preferred embodiment.

In addition, the transport system 128 comprises a preferred embodiment of the protective device 134 in accordance with the present disclosure.

In the present example, the transport body 130 is a transport wheel 136 which can be driven to rotate about a vertical axis. The containers are received by the transport wheel 136 in a manner known per se.

The protective device 134 comprises a guide device 138 which forms a transport path 140 for the containers 102.

The transport system 128 is designed such that the containers 102 are moved by the transport body 130 through the transport path 140 so as to be accumulated. This can be understood in particular to mean that a container 102 leading in the transport path is pushed along the transport path 140 by the following containers 102 and in turn contributes to pushing a preceding container 102 along the transport path 140.

Contrary to the present description, it may be provided that the transport of the containers 102 is carried out differently. For example, the transport body 130 can be or comprise a screw conveyor. It is also conceivable to use a conveyor belt, a cell chain with transport links or a mover in case of magnetic levitation transport.

The transport path 140 extends to the outlet opening 126. With the transport path 140 cleared, the containers 102 can reach the outlet opening 126 and preferably pass through it.

In the present case, the transport path 140 has a floor guide 142 on which the containers 102 - i.e. the stable vials 104 - are moved. However, the present disclosure is not limited thereto. Alternatively, containers 102 could be transported hanging or lying flat.

In the transport path 140, the containers 102 are moved along a transport direction 144. The transport direction 144 can vary depending on the shape of the transport path 140.

The protective device 134 comprises the guide device 138, which in the present exemplary embodiment comprises a first guide body 146 and a second guide body 148. The first guide body 146 is a left-hand guide body for left-hand lateral guidance with respect to the transport direction 144, and the second guide body 148 is a right-hand guide body for right-hand lateral guidance with respect to the transport direction 144. The guide bodies 146, 148 are spaced apart from each other and define between them the transport path 140, which, on the underside, is delimited by the floor guide 142. The transport path 140 is dimensioned such that the containers 102 can be moved therein with little play.

In the protective device 134, the guide bodies 146, 148 are designed such that the transport path 140 comprises a curved portion 150 on the supply side which forms a curve and is arranged downstream of the transport body 130. The curved portion 150 is followed by a straight portion 152, extending to the outlet opening 126.

On the upper side, facing away from the floor guide 142 in the present case, the guide bodies 146, 148 each comprise an essentially plate-shaped cover element 154. In the guide body 146, the cover element 154 covers a receiving space 156. The receiving space 156 transitions into a recess 158 of the guide body 146 in the transport direction 144, which also extends in the region of the cover element 154 so that the recess 158 is not covered by the cover element 154.

To increase operational safety, the protective device 134 comprises a securing element 160 and a blocking element 162. With respect to the transport direction 144, the containers 102 first pass the securing element 160 and then the blocking element 162. The blocking element 162 releases the transport path 140 only when the containers 102 have previously passed the securing element 160. This is explained below. The blocking element 162 is largely protected against external manipulation due to operating personnel reaching into the working chamber 112 through the outlet opening 126.

The securing element 160 in this case has a securing body 164, which can, for example, be designed to be disk-shaped. The securing body 164 is dimensioned such that it can be received in the receiving space 156 below the cover element 154, wherein it is movable back and forth relative to the guide body 146.

In particular, the securing element 160 is pivotably mounted on the guide body 146. In the present case, the corresponding bearing elements are a bearing pin 166 of the guide body 146 and a bearing receptacle 168 of the securing element 160. The bearing pin 166 defines a pivot axis 170. In the present case, the pivot axis is oriented transversely and, in particular, perpendicularly to the transport path 140 and is, for example, a z-axis, in particular a vertical axis.

The pivoting of the securing element 160 can be counter to the restoring force of a restoring element 172. The restoring element 172 is in this case a mechanical spring element, designed as a coil spring 174. The coil spring 174 is supported on the guide body 146 and on the securing element 160.

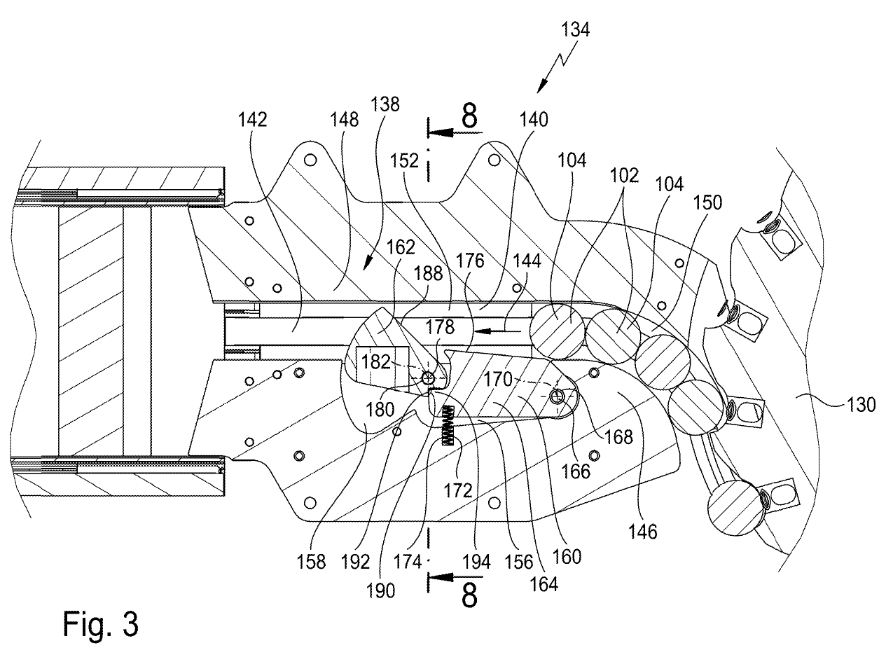

The securing element 160 can assume a securing position without a supplied container being present (FIG. 3). In this case, the securing element is subjected to the restoring force such that it engages, in portions, with the free cross-section of the transport path 140. In this case, the securing element 160 engages only to a relatively minor extent. However, it is important that a supplied container is able to contact the securing element 160.

For contact with the container 102, the securing element 160 has a sliding surface 176 which is oriented obliquely in relation to the transport direction 144 and is designed to be planar in the present case.

The pivot axis 170 is arranged on the securing element 160 so as to be leading with respect to the transport direction 144 (FIG. 4). In the present case, the restoring element 172 is arranged on an end portion of the securing element 160 facing away from the pivot axis 170.

A supplied container moves in the transport path 140 and comes into contact with the sliding surface 176. As the container 102 continues to move, the securing element 160 is subjected to a force and pivots against the action of the restoring element 172. If there is no force exerted by a container, the securing element 160 returns to its original position.

Alternatively or additionally, the securing element 160 can, for example, be held in the disengaged position by means of the blocking element 162, as mentioned below.

In functional terms, the blocking element 162 is designed to correspond to the securing element 160. As can be seen, for example, in FIGS. 4 - 7, the blocking element 162 in the present case has approximately the shape of a flap which can be actuated by the containers 102.

To save weight, the blocking element 162 can be designed as a hollow body in portions (FIG. 4).

The blocking element 162 is pivotably mounted on the guide body 146. Corresponding bearing elements are a bearing pin 178 of the guide body 146 and a bearing receptacle 180 of the blocking element 162.

The bearing pin 178 defines a pivot axis 182. The pivot axis 182 is oriented transversely and in particular perpendicularly to the transport path 140 and, in the present case, is parallel to the pivot axis 170. The pivot axis 182 can be a z-axis, in particular a vertical axis.

The blocking element 162 can be pivoted relative to the guide body 146 against the action of a restoring element 184. In the present case, the restoring element 184 is a mechanical spring element designed as a torsion spring 186 (FIG. 8). The torsion spring 186 surrounds the bearing pin 178 and is fixed to it. A leg not shown in the drawing engages the blocking element 162.

The blocking element 162 is dimensioned such as to be arranged in the recess 158, wherein it projects beyond the cover element 154, i.e. upwards in this case. It may prove advantageous, for example, if the blocking element 162 is designed to be at least as high as the containers 102, preferably higher.

The pivot axis 182 is arranged on the blocking element 162 so as to be leading with respect to the transport direction 144.

In a plan view of the guide device 138, the blocking element 162 essentially has the shape of a circular sector. The angle of the circular sector is, for example, approximately 30° to 50°. The blocking element 162 extends from the end portion in which the pivot axis 182 is arranged.

Under the action of the restoring element 184, the blocking element 162 can engage in the transport path 140. It is possible to completely or substantially completely block the free cross-section of the transport path 140.

The blocking element 162 comprises a sliding surface 188 in the transport path 140. The sliding surface 188 is oriented obliquely with respect to the transport direction 144 and is designed to be planar in the present case.

When a container 102 comes into contact with the sliding surface 188, the blocking element 162 is pivoted out of the transport path 140 and into the recess 158, so that the transport path 140 is cleared for the container 102.

The interaction of the securing element 160 and the blocking element 162, as well as their further design, are explained below.

The blocking element 162 can be blocked against a pivoting movement by means of the securing element 160. For this purpose, the securing element 160 comprises a blocking member 190, and the blocking element 162 comprises a corresponding blocking member 192. The blocking members 190, 192 can interact to secure the blocking element 162.

As can be seen, for example, from FIG. 3 in particular, the blocking members 190, 192 are corresponding stops that can be mechanically engaged with each other.

The blocking member 190 is arranged at the end of the securing element 160 with respect to the transport direction 144. The blocking member 190 is designed as a projection 194.

The blocking member 192 is arranged leading in the region of the pivot axis 182 on the blocking element 162 with respect to the transport direction 144. The blocking member 192 is designed as a cutout 196 in which the projection 194 can engage.

The blocking members 190, 192 can be disengaged so that the transport path 140 can be cleared for the containers 102.

When used as intended, as long as the containers 102 are not yet in contact with the securing element 160 and the blocking element 162, these elements 160 and 162 each assume a basic position. It is assumed that the containers 102 are arranged upstream of the securing element 160 on the supply side (FIG. 3).

Under the action of the restoring element 184, the blocking element 162 is pivoted into the transport path 140 and blocks it. The base position corresponds to a blocking position of the blocking element 162, in which the transport path 140 is blocked.

In the blocking position, the blocking element continues to engage in the recess 158. This prevents an operator from reaching into the recess 158 from the outside, thus securing the blocking element 162 against manipulation.

The securing element 160 is pivoted into the transport path 140 under the action of the restoring element 172. As a result, the blocking members 190, 192 are mechanically engaged with each other. The projection 194 extends into the cutout 196 and lies at its edge. The securing element 160 thereby secures the blocking element 162 against pivoting out of the transport path 140. The base position of the securing element 160 is accordingly also referred to as the securing position.

The transport path 140 can be cleared under the movement of the containers 102. The containers 102 in a way clear their own way through the transport path 140.

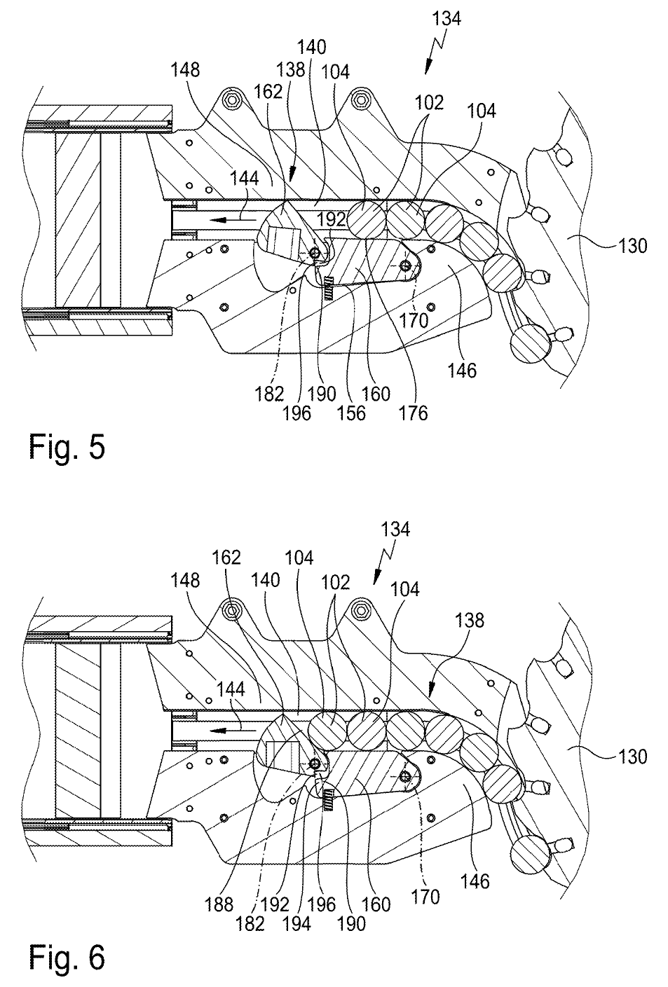

A supplied container contacts the sliding surface 176. This results in the engagement between the blocking members 190, 192 being removed (FIGS. 4 and 5). The securing element 160 is pivoted about the pivot axis 170 by the force applied by the container 102. The pivoting takes place counter to the restoring force of the restoring element 172 and into the receiving space 156 (FIGS. 4 and 5). The blocking members 190, 192 are disengaged, which is why the pivoted position of the securing element 160 can be described as disengaged position.

The securing element 160 can be held in the disengaged position by means of the containers 102 as long as they contact the sliding surface 176. While one container 102 passes the securing element 160, the next container 102 reaches the sliding surface 176, so that the blocking members 190, 192 remain out of engagement (FIG. 6).

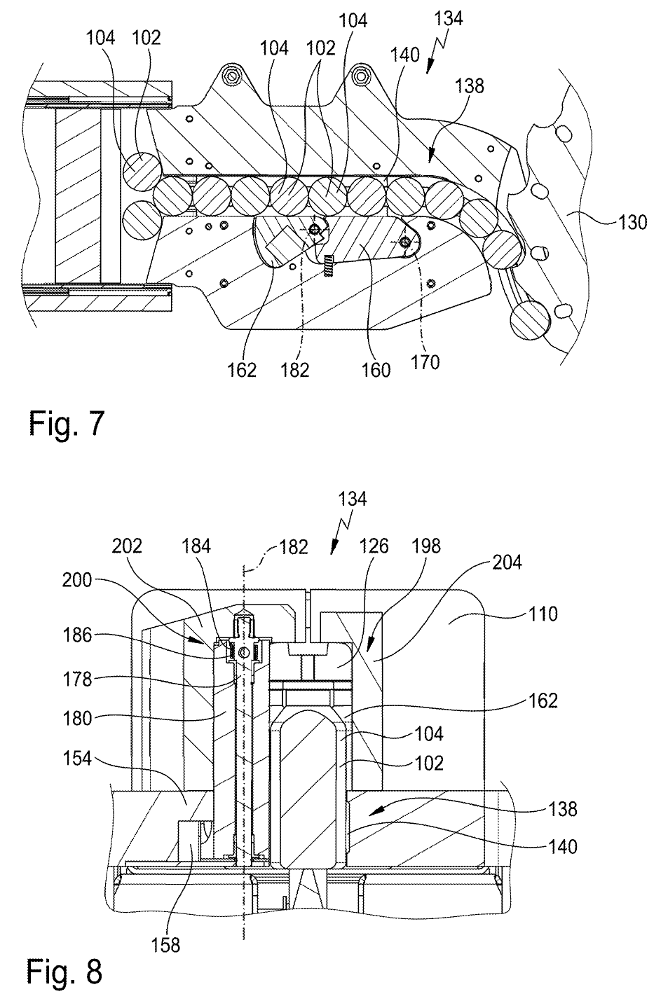

Alternatively or additionally, it may be provided for the securing element 160 to be held in the disengaged position by means of the blocking element 162 (see FIG. 7) assuming the release position. For example, the securing element 160 and the blocking element 162 can engage with each other by means of positive-locking and/or force-locking engagement and for this purpose can comprise corresponding blocking members which are, for example, functionally identical to the blocking members 190, 192. If the blocking element 162 is returned to the blocking position by the restoring element 184, the engagement can be undone, so that the securing element 160 can also return to the securing position by means of the restoring element 172.

The leading container 102 then comes into contact with the sliding surface 188 of the blocking element 162 and can apply a force thereto (FIG. 6). This causes the blocking element 162 to pivot about the pivot axis 182. The pivoting movement is made possible by the fact that the blocking members 190, 192 no longer abut each other and can block the pivoting movement of the blocking element 162.

As a result of the movement of the container 102, the blocking element 162 pivots from the blocking position into the recess 158 until it reaches a position in which the leading container 102 is first moved along the transport path 140 to the outlet opening 126. Subsequent containers also contact the blocking element 162 and are in turn moved to the outlet opening 126 under the thrust of subsequent containers 102. Due to the containers 102 being moved so as to accumulate, the securing element 160 remains in the disengaged position and the blocking element 162 remains in the release position (FIG. 7).

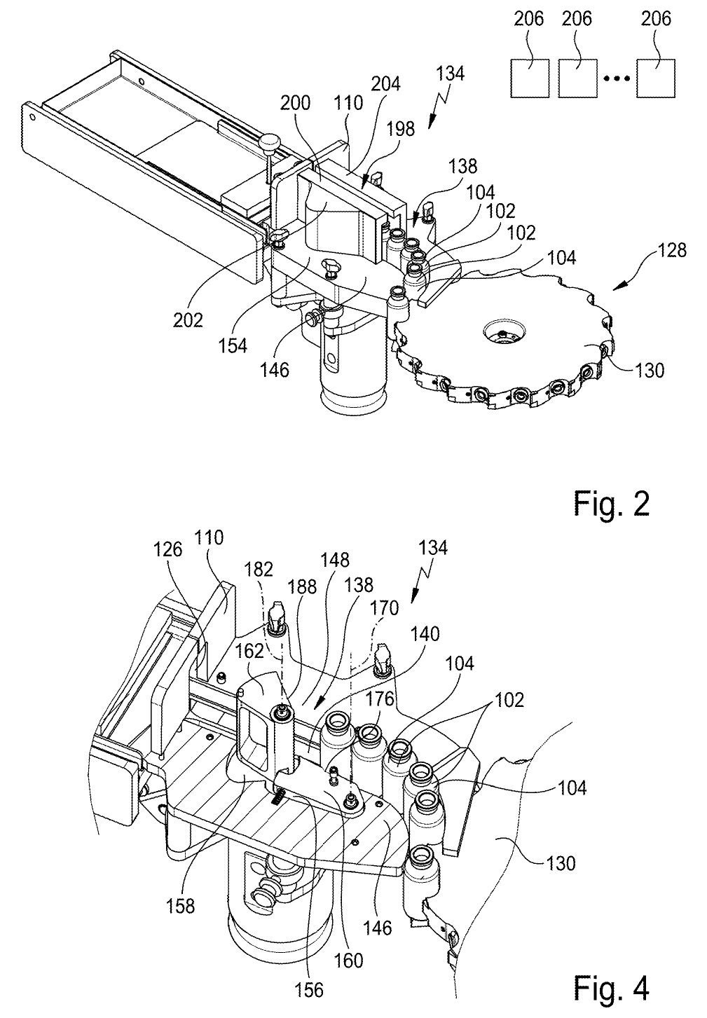

As can be seen in particular from FIGS. 2 and 8, the protective device 134 comprises a tunnel 198 to further increase operational safety. In the working chamber 112, the tunnel 198 is positioned upstream of the outlet opening 126. In the present case, the tunnel 198 comprises a wall arrangement 200, which has two portions 202, 204.

In this case, the guide body 146 forms the portion 202 and the guide body 148 forms the portion 204. This makes a structurally simple configuration of the tunnel possible.

The tunnel 198 covers the blocking element 162 and the guide bodies 146, 148 in the region of the securing element 160 so that the elements 160, 162 are even better protected against manipulation from the outside. This is already largely impossible for the securing element 160 because it is arranged in the receiving space 156 below the cover element 154 and is therefore not directly accessible to an operator.

The tunnel 198 forms part of the protective device 134, in particular when the containers 102 are arranged therein. For example, if the containers 102 have transferred the securing element 160 into the disengaged position, the blocking element 162 could possibly be opened from the outside if the blocking members 190 and 192 are no longer engaged with each other. Even if the operator could reach through the outlet opening 126, passage would still be blocked due to the tunnel 198 and the containers 102 arranged therein. The containers 102 that have accumulated cannot be moved inwards in the opposite direction to the transport direction 144 because of the transport wheel 136, neither when the transport wheel 136 is active nor when it is stationary.

It is advantageous for the protective device 134 to comprise a plurality of format sets 206. A respective format set 206 can comprise several format parts, wherein the format parts of different format sets 206 differ from each other in terms of their container-specific properties. This provides the possibility of a structurally simple and versatile conversion of the protective device 134 between different formats of containers 102.

It may also be intended that each format set 206 covers a predefined format range.

Format parts can be, for example, the guide bodies 146, 148, the blocking element 162 and the tunnel 198 (for example, the portions 202 and 204). In an advantageous implementation, the securing element 160 is, for example, format-independent. In a different implementation, the securing element 160 can also be a format part.

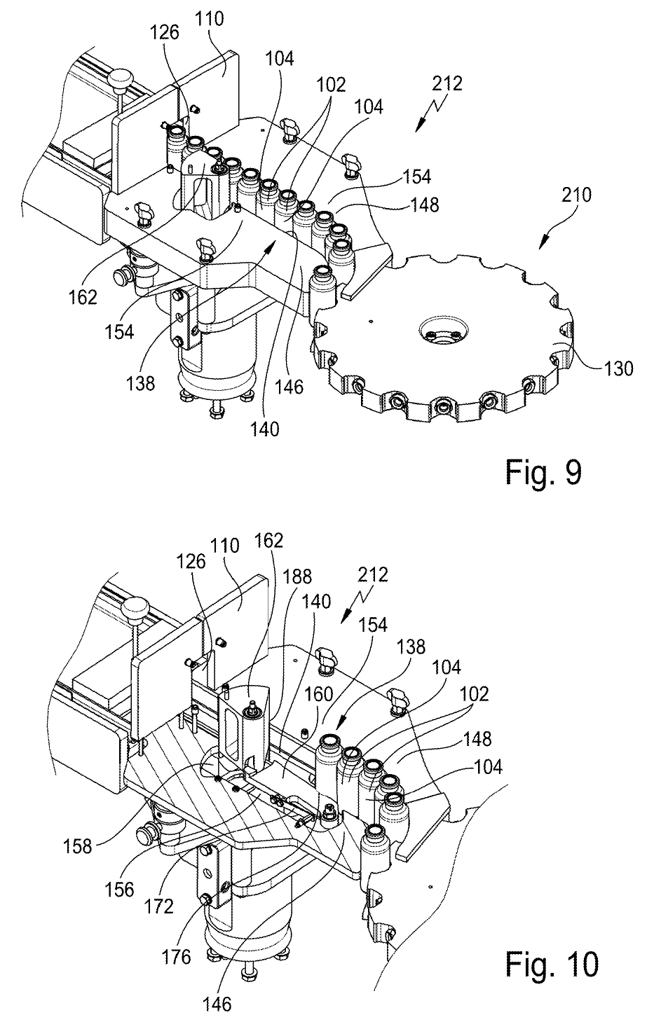

Further preferred embodiments of the device and transport system in accordance with the present disclosure are explained below with reference to FIGS. 9 - 17. Identical or functionally equivalent features and components are always given the same reference numerals. The advantages explained in connection with the transport system 128 and the protective device 134 are also achieved with the protective devices and the transport system explained below, so that to avoid repetition reference can be made to the preceding explanations in this regard. Only the major differences will be discussed.

A transport system in accordance with the present disclosure in a preferred embodiment is partially shown in FIGS. 9 -12 and is designated there by reference numeral 210. The transport system 210 comprises a preferred embodiment of the protective device in accordance with the present disclosure, which is designated by reference numeral 212.

In terms of functionality, the operating principle of the protective devices 134 and 212 is identical.

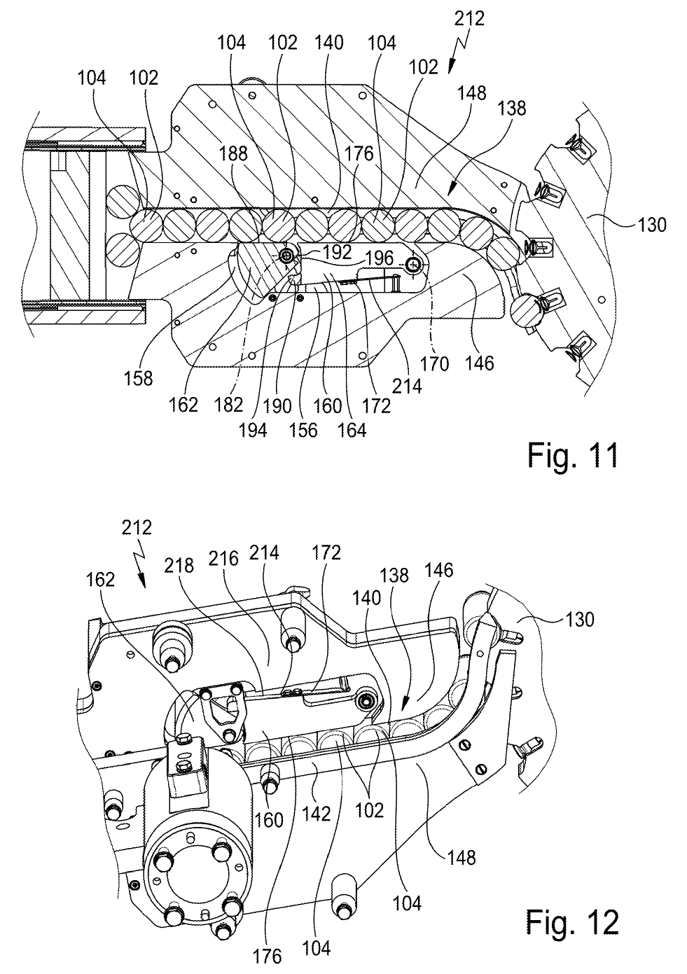

Unlike the protective device 134, the restoring element 172 for the securing element 160 in the protective device 212 is not designed as a coil spring 174 but as a leaf spring 214 (FIGS. 11 and 12).

The guide body 146 is partially open in the protective device 212 (FIG. 12). A cover element 216 arranged on the underside has a recess 218 in the region of the securing element 160 and the blocking element 162. In practice, it has been shown that this improves the cleaning properties for the protective device 212.

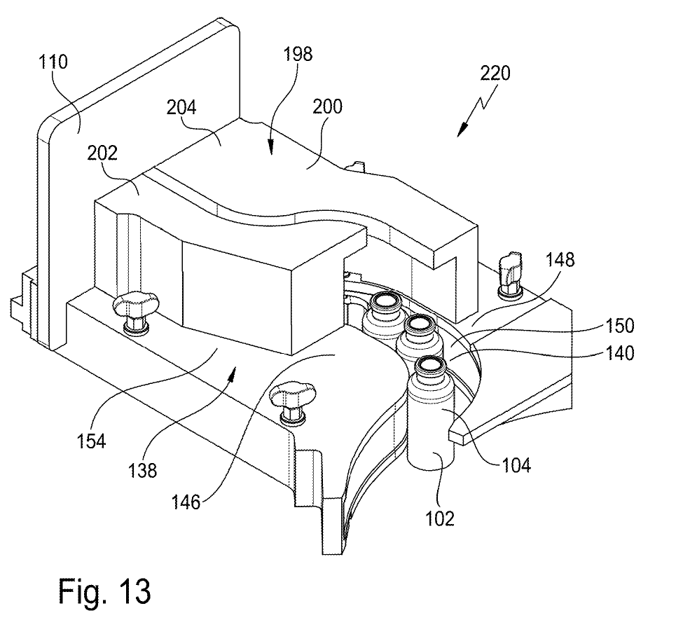

FIGS. 13 through 17 show a preferred embodiment of the protective device in accordance with the present disclosure, denoted by reference numeral 220. The protective device 220 can be part of the transport system 128 or 210 in accordance with the present disclosure.

In the protective devices 134, 212, the second portion 152 of the transport path 140 is designed to be straight. In contrast, in case of the protective device 220, the transport path 140 has a second portion 222 which is formed in the form of an S-chicane.

Unlike the protective devices 134, 212, the securing element 160 and the blocking element 162 are arranged on the right-hand lateral guide formed by the guide body 148. However, this is not a limiting factor for the present disclosure. Such an arrangement on a right-hand side guide could also be provided in the protective devices 134, 212. Conversely, elements 160, 162 could be arranged on a left-hand lateral guide in the protective device 220.

In the protective device 220, the securing element 160 is displaceably mounted on the guide body 148 in order to be transferred from the securing position to the disengaged position, and vice versa. Corresponding bearing elements comprise bearing pins 224 on the guide body 148, which engage with bearing receptacles 226 of the securing element 160. The bearing receptacles 226 are designed as elongated holes.

The restoring force is applied by two restoring elements 172 designed as coil springs 174.

At the portion 222 the sliding surface 176 is adapted in shape to the contour of the transport path 140 and is accordingly arcuate. The blocking element 162 is arranged on the exit side of the s-shaped portion 222.

In terms of functionality, the protective device 220 is designed to correspond to the protective devices 134 and 212. First, the securing element 160 is transferred from the securing position to the disengaged position under the action of a container 102, thereby undoing the engagement of the blocking members 190, 192. The container 102 then transfers the blocking element 162 from the blocking position to the release position.

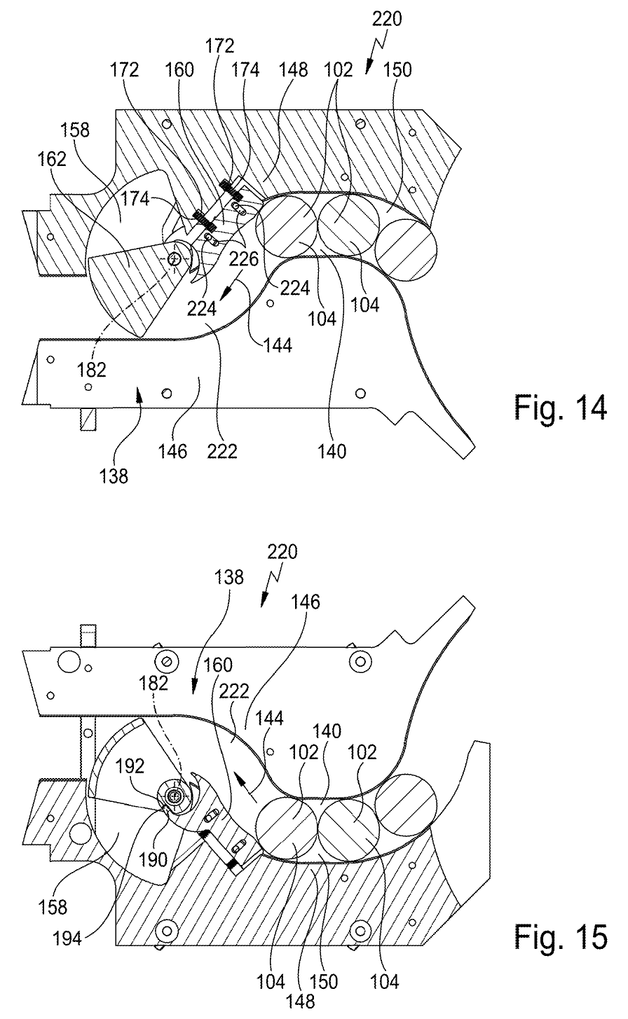

FIGS. 14 and 15 show the situation when the container 102 begins to make contact with the securing element 160 from above and from below, respectively (in each case as a sectional representation).

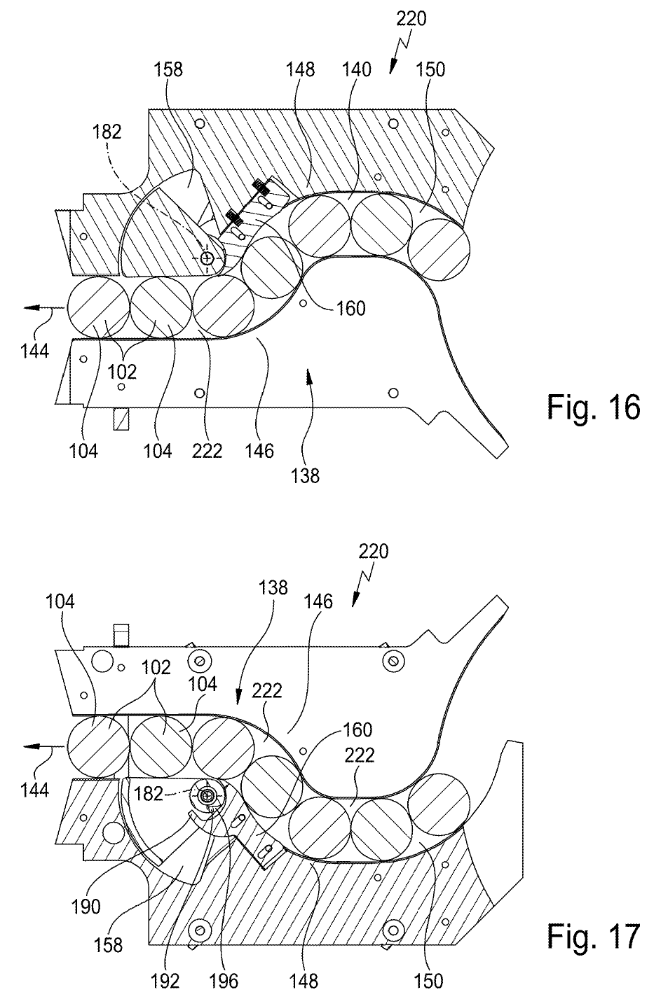

Similarly, FIGS. 16 and 17 show the situation with the transport path 140 cleared from above and from below, respectively.

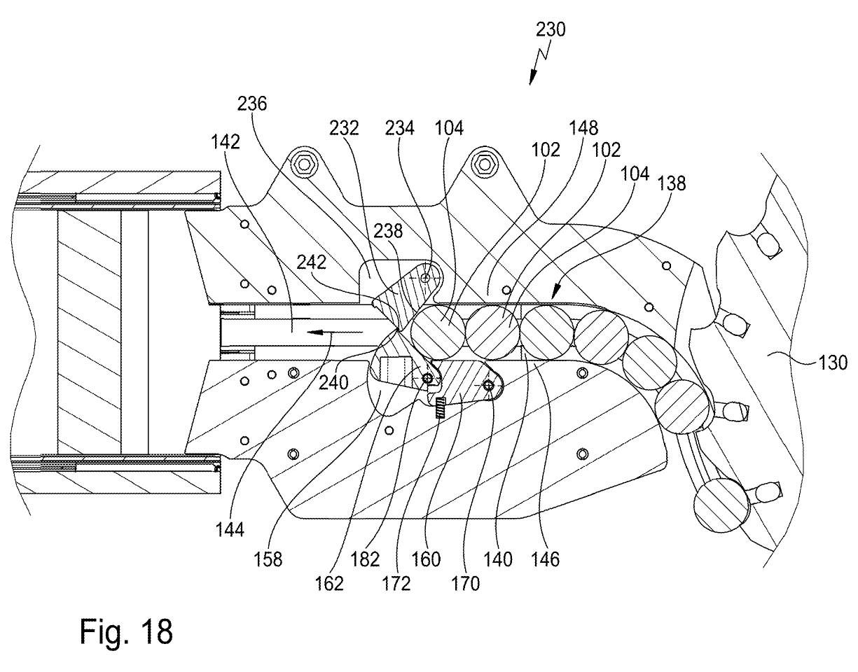

FIG. 18 shows a protective device in accordance with the present disclosure, designated by reference numeral 230, in a preferred embodiment in a partial representation and at a time that corresponds to the time shown in FIG. 6 for the protective device 134. The protective device 230 can be part of the transport system 128 or 210 in accordance with the present disclosure. FIG. 18 also shows the transport body 130 in portions for this purpose.

In the case of the protective device 230, the blocking element 162 is of a compact design compared to the protective devices 134, 212 and 220. Along the transport direction, the blocking element 162 is extended in such a way that it can be contacted by only one container 102. It therefore has a short length only.

As a result, the blocking element 162 is dimensioned in such a way that in the blocking position shown in FIG. 18 it only partially blocks the free cross-section of the transport path 140, in the present example about half thereof.

To further block the transport path 140, the protective device 230 comprises a further blocking element 232. The further blocking element 232 is arranged on a side opposite the blocking element 160 on the transport path 140, in this case on the right-hand lateral guide of the guide device 138.

The further blocking element 232 also allows wider transport paths 140 for containers 102 with larger diameters to be covered with short blocking elements 162, 232 and relatively small guides, in particular since with such a design it is not necessary for two containers 102 to abut the blocking elements 162, 232.

The further blocking element 232 can also be transferred from a blocking position blocking the transport path 140 for the containers 102 to a release position clearing the transport path 140, and vice versa. For this purpose, the further blocking element 232 is designed to be largely functionally identical to the blocking element 162.

For example, the further blocking element 232 can be pivoted relative to the guide device from the blocking position shown in FIG. 18 about a pivot axis 234 relative to the guide device 138 into the release position. The guide device 138 has a pivotable bearing via corresponding bearing elements.

In the blocking position, the further blocking element 232 blocks approximately half of the free cross-section of the guide path 140. In the release position, the further blocking element 232 is arranged in a recess 236 of the guide body 148.

The pivoting takes place under the action of a supplied container 102, which contacts a sliding surface 238 of the further blocking element 232. In this case, it also has approximately the shape of a flap that can be actuated by the containers 102 and held in the release position. The extension along the transport direction 144 is such that only one container 102 contacts the further blocking element 232.

A restoring element is provided (not shown), under the action of which the pivoting from the release position to the blocking position takes place, and against the action of which the pivoting from the blocking position to the release position takes place.

The blocking element 162 and the further blocking element 232 can engage with each other when assuming the respective blocking position, in this case in a positive-locking manner. For this purpose, corresponding blocking members 240, 242 are provided, which are designed as stop elements. In this case, the blocking element 162 secures the further blocking element 232. This eliminates the need for a separate securing element for the further blocking element 232.

During operation, a supplied container 102 contacts the blocking element 162 and begins to transfer it in the release position, thereby undoing the engagement with the further blocking element 232. The container 102 then contacts the further blocking element 232 in order to also transfer it to the release position.

In the case of the protective device 230, the securing element 162 folds back towards the blocking position after a container 102 has passed through, due to its small extension in the transport direction 144. To avoid this, it can be provided for the blocking element 162 to be held in the release position by means of the securing element 160 assuming the disengaged position.

For example, the securing element 160 and the blocking element 162 can engage with each other by positive-locking and/or force-locking engagement. For this purpose, for example, blocking members in the form of stop elements are provided, as explained by the example of the blocking members 190, 192, 240, 242. As long as the securing element 160 is in the disengaged position, the blocking element will be held in the blocking position. It is advantageous if the securing element 160 can be contacted by two consecutive containers. For example, the securing element 160 has a small pivot angle and a format-independent contour.

If the force on the securing element 160 ceases to apply, for example when the transport path 140 is running empty, the securing element 160 can be moved back into the securing position. As a result, the engagement with the blocking element 162 can be undone, so that the blocking element 162 can also return to the blocking position, in which it is again blocked by the securing element 160.

It goes without saying that such an engagement between the blocking element 162 in the release position and the securing element 160 in the disengaged position is also conceivable for the other protective devices 134, 212 and 220.

### LIST OF REFERENCE NUMERALS

100 System
102 Container
104 Vial
106 Frame
108 Set-down surface
110 Wall arrangement
112 Working chamber
114 Processing station
116 Crimping station
118 Inlet
120 Outlet
121, 122 Reject chute
123, 124 Removal region
126 Outlet opening
128 Transport system
130 Transport body
132 Drive unit
134 Protective device
136 Transport wheel
138 Guide device
140 Transport path
142 Floor guide
144 Transport direction
146, 148 Guide body
150 First portion
152 Second portion
154 Cover element
156 Receiving space
158 Recess
160 Securing element
162 Blocking element
164 Securing body
166 Bearing pin
168 Bearing receptacle
170 Pivot axis
172 Restoring element
174 Coil spring
176 Sliding surface
178 Bearing pin
180 Bearing receptacle
182 Pivot axis
184 Restoring element
186 Torsion spring
188 Sliding surface
190, 192 Blocking member
194 Projection
196 Cutout
198 Tunnel
200 Wall arrangement
202, 204 Portion
206 Format set
210 Transport system
212 Protective device
214 Leaf spring
216 Cover element
218 Recess
220 Protective device
222 Second portion
224 Bearing pin
226 Bearing receptacle
230 Protective device
232 Further blocking element
234 Pivot axis
236 Recess
238 Sliding surface
240, 242 Blocking member

1. A protective device for a system for processing pharmaceutical containers, wherein the protective device is positioned or is positionable in the system, comprising:
a guide device which comprises or forms a transport path through which the pharmaceutical containers are conveyable; and
a blocking element which is arranged on the transport path and which is transferable from a blocking position, which blocks the transport path for the pharmaceutical containers, to a release position, which releases the transport path for the pharmaceutical containers, and vice versa,
wherein
the protective device comprises a securing element which is arranged on the transport path and which is transferable from a securing position to a disengaged position and vice versa, wherein in the securing position, the securing element blocks the blocking element, assuming the blocking position, from moving to the release position, and in the disengaged position, the blocking element is transferable from the blocking position to the release position, and wherein the securing element is positioned upstream of the blocking element in a supply direction of the pharmaceutical containers, is contactable by a supplied container, and is transferable from the securing position to the disengaged position as a result of movement of the supplied container.

2. The protective device according to claim 1,
wherein
at least one of the following applies:
the blocking element is only transferable from the blocking position to the release position if the securing element has previously been transferred from the securing position to the disengaged position;
the securing element is held in the disengaged position by means of one container or several containers;
the securing element is held in the disengaged position by means of the blocking element.

3. The protective device according to claim 1,
wherein
the securing element, in the securing position, engages the transport path, from a left-hand side and/or a right-hand side of the transport path, with respect to a transport direction of the pharmaceutical containers in the transport path.

4. The protective device according to claim 1,
wherein
in the disengaged position, the securing element is arranged completely outside a free cross-section of the transport path.

5. The protective device according to claim 1,
wherein
the guide device comprises a guide body with a cover element, the securing element, in the disengaged position, being received in a receiving space covered by the cover element.

6. The protective device according to claim 1,
wherein
the securing element comprises a sliding surface for the pharmaceutical containers, wherein the sliding surface is arranged obliquely relative to a transport direction of the pharmaceutical containers in the transport path, or the sliding surface is designed in an arcuate shape.

7. The protective device according to claim 1,
wherein:
the securing element is designed to be pivotable on the guide device about a pivot axis via interacting bearing elements, and
the pivot axis is oriented transversely to the transport path and/or arranged on the securing element so as to be leading with respect to a transport direction of the pharmaceutical containers.

8. The protective device according to claim 1,
wherein
the securing element is designed to be displaceable on the guide device via interacting bearing elements, wherein a displacement direction is to a transport direction of the pharmaceutical containers.

9. The protective device according to claim 1,
wherein
the protective device comprises or forms a restoring element for providing a restoring force, in response to which the securing element is transferable from the disengaged position to the securing position, wherein the securing element is transferable from the securing position to the disengaged position against the restoring force.

10. The protective device according to claim 1,
wherein
at least one of the following applies:
an extension of the securing element along the transport path is such that it is contactable by at least two containers;
the blocking element is arranged immediately downstream of the securing element in a transport direction of the pharmaceutical containers, and a container simultaneously contacts the securing element and the blocking element.

11. The protective device according to claim 1,
wherein
the securing element and the blocking element comprise interacting blocking members which, in the securing position of the securing element and in the blocking position of the blocking element, are in a mechanical engagement with each other, wherein the mechanical engagement is released in the securing element assuming the disengaged position.

12. The protective device according to claim 11,
wherein
a blocking member of the securing element is arranged at an end of the securing element with respect to a transport direction and/or wherein a blocking member of the blocking element is arranged at the blocking element so as to be leading with respect to the transport direction.

13. The protective device according to claim 11,
wherein
the guide device comprises a guide body with a cover element, and wherein the blocking members are arranged in a receiving space covered by the cover element.

14. The protective device according to claim 1,
wherein
the blocking element, in the blocking position, engages the transport path from a left-hand side and/or a right-hand side of the transport path, with respect to a transport direction of the pharmaceutical containers in the transport path, and/or wherein, for transfer into the disengaged position and the release position, the securing element in the securing position and the blocking element in the blocking position engage the transport path from the same side and are movable in the same direction out of the transport path.

15. The protective device according to claim 1,
wherein
in the release position, the blocking element is arranged completely outside a free cross-section of the transport path.

16. The protective device according to claim 1,
wherein
the guide device forms a recess in which the blocking element is arranged in the release position, wherein the recess is arranged laterally next to the transport path, wherein, for transfer from the release position into the blocking position, the blocking element is movable from the recess into the transport path, but continues to engage the recess in the blocking position.

17. The protective device according to claim 1,
wherein
at least one of the following applies:
the blocking element is contactable by a supplied container and is transferable from the blocking position to the release position as a result of the movement of the supplied container;
the blocking element is held in the release position by means of one container or several containers.

18. The protective device according to claim 1,
wherein
at least one of the following applies:
the blocking element comprises a sliding surface for the pharmaceutical containers, wherein the sliding surface is arranged obliquely relative to a transport direction of the pharmaceutical containers in the transport path;
the blocking element extends along the transport path in such a way that the blocking element is contactable by at least two containers or the blocking element extends along the transport path in such a way that it is contactable by only one container.

19. The protective device according to claim 1,
wherein
the blocking element is designed to be pivotable on the guide device about a pivot axis via interacting bearing elements, the pivot axis being oriented transversely to the transport path and/or being arranged on the blocking element so as to be leading with respect to a transport direction of the pharmaceutical containers.

20. The protective device according to claim 19,
wherein
the securing element and the blocking element comprise interacting blocking members, the blocking member of the blocking element being arranged in the region of the pivot axis on the blocking element.

21. The protective device according to claim 1,
wherein
the protective device comprises or forms a restoring element for providing a restoring force in response to which the blocking element is transferable from the release position to the blocking position, wherein the blocking element is transferable from the blocking position to the release position against the restoring force.

22. The protective device according to claim 1,
wherein
the protective device comprises a further blocking element which in a blocking position engages in the transport path from a side opposite the blocking element and is transferable into a release position, and vice versa, wherein the further blocking element releases the transport path in the release position.

23. The protective device according to claim 22,
wherein
the blocking element and the further blocking element engage with each other when assuming the respective blocking position, wherein the blocking element blocks the further blocking element against transfer from the blocking position to the release position, or vice versa.

24. The protective device according to claim 1,
wherein
the blocking element is held in the release position by means of the securing element assuming the disengaged position.

25. The protective device according to claim 1,
wherein
a contour of the blocking element has the form of a circular arc in a plan view of the transport path.

26. The protective device according to claim 1,
wherein
the protective device comprises or forms a tunnel through which the pharmaceutical containers are movable in the transport path and which covers the blocking element and/or the securing element.

27. The protective device according to claim 26,
wherein
the guide device comprises two guide bodies arranged at a distance from each other, between which the transport path is formed, and a respective guide body forms, in portions, a wall arrangement of the tunnel.

28. A transport system, comprising:
the protective device according to claim 1;
a transport body; and
a drive unit for the transport body,
wherein the pharmaceutical containers are conveyable into or in the transport path by means of the transport body.

29. A system for processing pharmaceutical containers, the system comprising:
the transport system according to claim 28;
a working chamber with at least one processing station for the pharmaceutical containers arranged in the working chamber; and
a wall arrangement for delimiting the working chamber,
wherein an outlet opening is formed in the wall arrangement through which the pharmaceutical containers are conveyable by the transport system,
wherein the protective device is arranged inside or outside the working chamber, and
wherein the transport path extends to the outlet opening or passes through the outlet opening.
